(19) United States
(12) Patent Application Publication
(10) Pub. No.: US 2020/0031181 A1
(43) Pub. Date: Jan. 30, 2020

(54) SPHERICAL TIRE PRESSURE DETECTION DEVICE

(71) Applicant: CUB ELECPARTS INC., Changhua County (TW)

(72) Inventors: SAN-CHUAN YU, Changhua County (TW); TUNG-FENG LIN, Changhua County (TW); ZHAO-SHAN QI, Changhua County (CN); TZU-WEN KO, Changhua County (TW); JIAN-CYUAN SHIH, Changhua County (TW)

(21) Appl. No.: 16/521,157

(22) Filed: Jul. 24, 2019

(30) Foreign Application Priority Data
Jul. 25, 2018 (CN) 201821186139.X
Jul. 25, 2018 (CN) 201821186794.5
Jul. 25, 2018 (CN) 201821186796.4

(51) Int. Cl. B60C 23/04

(52) U.S. Cl. CPC B60C 23/0491; B60C 23/0408

(57) ABSTRACT

A spherical tire pressure detection device includes a tire pressure detector and a ball body. The tire pressure detector has a casing and a tire pressure detection member disposed in the casing. The tire pressure detection member detects the tire pressure in the tire. The casing is removably housed in the ball body, facilitating the replacement of the tire pressure detector.

### BACKGROUND OF THE INVENTION

### 1. Field of the Invention

The present invention relates to tire pressure detection devices, and more particularly, to a spherical tire pressure detection device.

### 2. Description of the Related Art

A tire pressure detection device applies a wireless transmission technique for collecting statistics of a tire, such as the tire pressure and the temperature thereof, during the moving or static status of the vehicle by use of a wireless transductor which is disposed on a wheel of the vehicle, and the statistic is transmitted to the host machine of the driver room to be digitally displayed. When abnormality of the tire pressure or temperature occurs, a buzzing sound or voice is sent out for warning the driver, so as to assure the driving safety.

A conventional tire pressure detection device, such as disclosed by U.S. Pat. No. 6,591,672B2, comprises a detector and a valve stem. The valve stem is disposed on the frame of the wheel, and the detector is disposed in the tire for detecting the tire pressure thereof. Such conventional tire pressure detection device has to be disposed on the frame for placing the detector in the tire. Also, when the detector is out of work, the whole tire pressure detection device has to be disassembled for maintenance or replacement. However, the disassembling process of the assemblies causes a consumption of time, and a waste of components occurs during the installation process of the valve stem. Therefore, it is desirable for the industry to resolve such issues.

### SUMMARY OF THE INVENTION

For improving the issues above, the present invention discloses a spherical tire pressure detection device, which is provided with a tire pressure detector positioned in the ball body, so as to be placed into the tire for detection the tire pressure thereof, wherein the tire pressure detector is allowed to be disassembled from the ball body.

For achieving the aforementioned objectives, a spherical tire pressure detection device in accordance with an embodiment of the present invention comprises a tire pressure detector and a ball body. The tire pressure detector comprises a casing and a tire pressure detection member disposed in the casing for detecting the tire pressure in the tire. The ball body is hollow, with a fixing portion disposed therein, and a housing space formed in the fixing portion. The casing is placed in the housing space to be positioned by the fixing portion, and the casing is allowed to be removed from the ball body.

Also, a spherical tire pressure detection device in accordance with another embodiment of the present invention is provided, comprising a tire pressure detector and a ball body. The tire pressure detector comprises a casing and a tire pressure detection member disposed in the casing for detecting the tire pressure in the tire. When having the tire pressure detector therein, the gravity center of the ball body is placed at the geometric center of the ball body.

Preferably, a shock absorber is further included, which is hollow and mounted around the ball body, thereby providing a shock absorption effect during the rolling of the ball body.

Preferably, the ball body has a plurality of lump portions formed on the outer surface, wherein the center of each lump portion is convex from the periphery to the center thereof to form a cone shape.

With such configuration, the casing of the tire pressure detector is positioned in the ball body and placed in the tire for detecting the tire pressure through the tire pressure detection member. Also, when the detection function of the tire pressure detection member is damaged, the casing in which the tire pressure detection member is placed is able to be removed from the ball body, so that the tire pressure detection member is efficiently replaced. Therefore, the assembling process is efficient and facilitated, and the waste of components during the installation process of the valve stem is prevented.

Further, a shock absorber is mounted around the outer periphery of the ball body. When having the tire pressure detector placed in the tire for detecting the tire pressure, the ball body rolls along with the rotation of the wheel, such that the shock absorber provides an effective shock absorption, thereby preventing the tire pressure detector in the ball body from being damaged due to the shock.

Furthermore, the outer surface of the ball body is provided with a plurality of lump portions, wherein the center of each lump portion is convex from the periphery to the center thereof to form a cone shape. Therefore, when mist gathers on the ball body, the mist forms droplets on the top end of the lump portions. Subsequently, the droplets will be threw off from the rolling ball body, so as to prevent the mist attached on the ball body from penetrating into the ball body to cause the damage upon the tire pressure detector. Also, the cone-shaped lump portion provides a shock absorption effect as well.

### BRIEF DESCRIPTION OF THE DRAWINGS

FIG. 1 is an exploded view of the spherical tire pressure detection device in accordance with an embodiment of the present invention.

FIG. 2 is a perspective view of the spherical tire pressure detection device in accordance with an embodiment of the present invention.

FIG. 3 is an enlarged schematic view illustrating the ball body and the connection bore in accordance with an embodiment of the present invention.

FIG. 4 is a partially enlarged cross-sectional view taken along line 4-4 of FIG. 3, illustrating the inner structure thereof and the connection bore.

FIG. 5 is a perspective view of the spherical tire pressure detection device in accordance with a second embodiment of the present invention.

FIG. 6 is a sectional schematic view illustrating the structure of the shock absorber mounted around the ball body in accordance with a second embodiment of the present invention.

FIG. 7 is a perspective view of the spherical tire pressure detection device in accordance with a third embodiment of the present invention.

FIG. 8 is a sectional view illustrating the spherical tire pressure detection device in accordance with a fourth embodiment of the present invention.

FIG. 9 is a sectional schematic view illustrating the structure of the shock absorber mounted around the ball body in accordance with a fifth embodiment of the present invention.

FIG. 10 is a perspective view of the spherical tire pressure detection device in accordance with a sixth embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

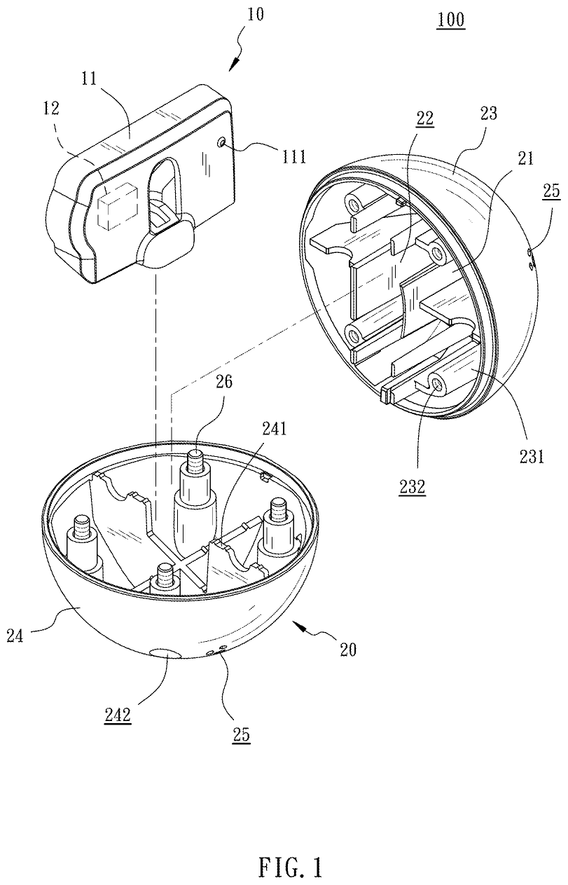

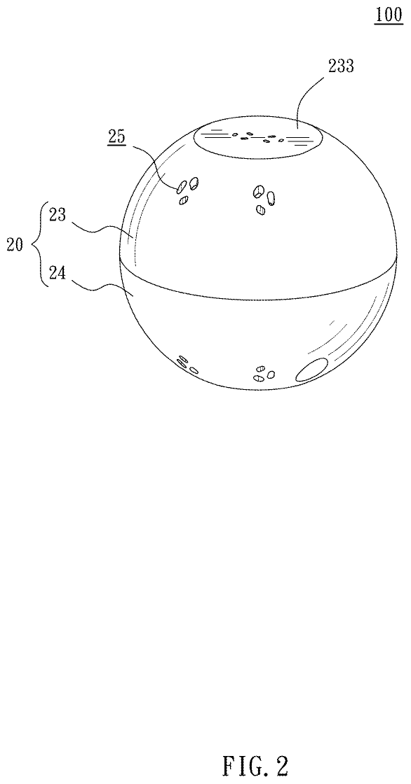

Referring to FIG. 1 to FIG. 4, a spherical tire pressure detection device 100 in accordance with a first embodiment of the present invention comprises a tire pressure detector 10 and a ball body 20.

The tire pressure detector 10 comprises a casing 11 and a tire pressure detection member 12 disposed in the casing 11. The casing 11 has a detection bore 111 allowing the internal air and the external air to communicate. When the tire pressure detection is carried out, the tire pressure is formed in the tire due to inflation, such that the detection bore 111 facilitates the balance between the internal and external pressure of the casing 11. Therefore, the tire pressure detection member 12 is able to detect the tire pressure in the tire. When the tire pressure detection member 12 acquires the tire pressure in the tire, the tire pressure is output to be displayed for informing the driver through a wireless transmission.

The ball body 20 is a hollow casing member, with a fixing portion 21 disposed in the ball body 20. In the embodiment, the fixing portion 21 is a partition formed together with the ball body 20, such that the partition forms a housing space 22. The casing 11 of the tire pressure detector 10 is placed in the housing space 22 and positioned by the fixing portion 21 in the ball body 20. Also, the casing 11 is able to be removed detached from the fixing portion 21. In the embodiment, the housing space 22 is smaller than the width of the casing 11, such that the casing 11 is allowed to be engaged by the fixing portion 21 and positioned in the housing space 22. Also, the casing 11 is allowed to be detached from the fixing portion 21 by an imposed force, so as to be removed from the housing space 22. Therefore, the tire pressure detector 10 in the ball body 20 is replaceable.

In the embodiment, the ball body 20 comprises a first ball casing 23 and a second ball casing 24, wherein at least one of the first ball casing 23 and the second ball casing 24 has a connection bore 25, which allows the internal space and the external space of the ball body 20 to communication. Preferably, the fixing portion 21 is disposed at the center position of one of the first ball casing 23 and the second ball casing 24. When the casing 11 is positioned by the fixing portion 21 in the housing space 22, the gravity center of the ball body 20 is at the geometric center of the ball body 20. In the embodiment, the fixing portion 21 and the housing space 22 are in the first ball casing 23, and the second ball casing 24 has a pressing portion 241. When the casing 11 is positioned by the fixing portion 21, the pressing portion 241 of the second ball casing 24 helps position the casing 11 in the housing space 22.

Preferably, the first ball casing 23 and the second ball casing 24 are formed in a hemispheric shape and combined into the ball body 20. Also, in the embodiment, the first ball casing 23 and the second ball casing 24 are provided with the connection bore 25, respectively. In embodiment, the first ball casing 23 and the second ball casing 24 are combined with screws 26. In the embodiment, a plurality of through holes 242 are disposed around the second ball casing 24, and the first ball casing 23 has a plurality of assembling pillars 231 at the positions corresponding to the through holes 242 of the second ball casing 24, wherein each assembling pillar 231 has an assembling bore 232. When a screw 26 pass through the through hole 242, the screw 26 is in aligned with the corresponding assembling bore 232 and screwed to the corresponding assembling pillar 231 for being positioned. Also, in the embodiment, the first ball casing 23 has a plane 233, and the second ball casing 24 has a plane 243, wherein the planes 233, 243 are positioned at two opposite ends of the ball body 20 which is formed by the combination of the first ball casing 23 and the second ball casing 24. When the planes 233, 243 meet a flat surface, the ball body 20 is able to stop rolling efficiently.

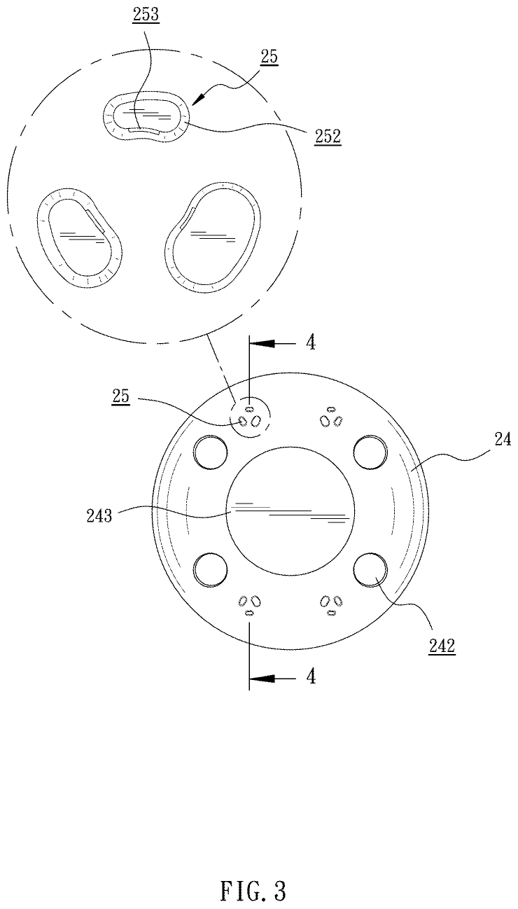

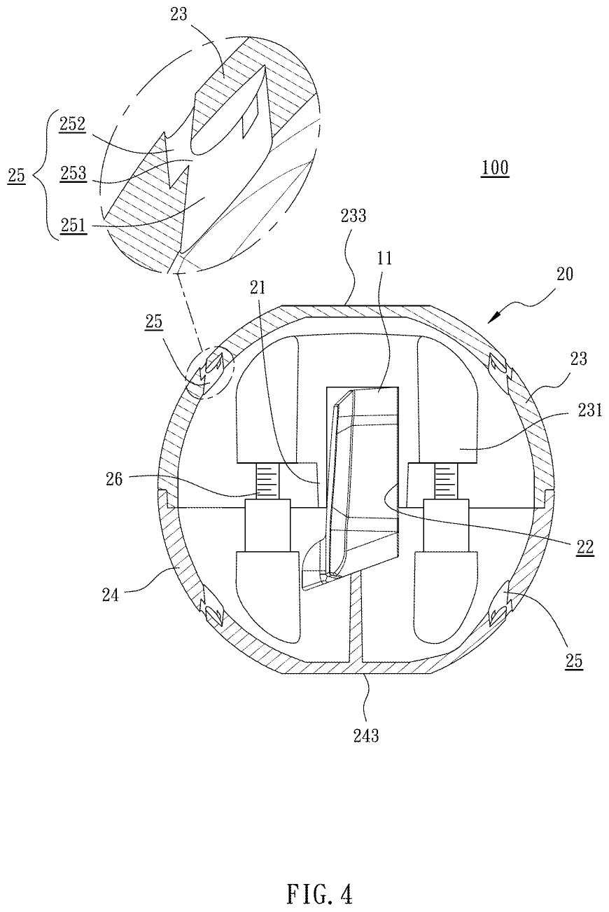

Further, the connection bore 25 has an inner section 251 and an outer section 252, wherein the inner section 251 is positioned on an inner side of the ball body 20 and in communication with the inner space of the ball body 20. The outer section 252 surrounds the inner section 251. Also, the aperture of the outer section 252 is formed in a tapering horn-shaped structure, with the smaller end of the outer section 252 placed toward the inner side of the ball body 20 and connected with the inner section 251 in a misalignment connection, wherein a channel 253 is formed at a lateral side of the outer section 252 and the inner section 251 for connecting the outer section 252 and the inner section 251 (as shown by FIG. 3 and FIG. 4). With the outer section 252 and the inner section 251 being connected through the channel 253, dust and mist are blocked and prevented from directly entering the ball body 20. Also, with the outer section 252 formed in a tapering horn shape, a plug is allowed to be applied (not shown) for ensuring that the dust and mist are unable to enter the ball body 20 from the connection bore 25.

Regarding the spherical tire pressure detection device 100, the tire pressure detector 10 is positioned in the housing space 22 by the fixing portion 21, so as to be installed in the ball body 20. Therefore, when placed in the inflated tire, the tire pressure detection member 12 is applied for detecting the tire pressure. Compared with the conventional tire pressure detection device which is installed on the frame of the wheel by use of the valve stem, the present invention provides an efficient and convenient installation advantage. Also, when the tire pressure detection of the tire pressure detection member 12 is inaccurate, malfunctioned, or damaged and unable to be carried out, the ball body 20 is able to be separated for efficiently removing the casing 11 of the tire pressure detector 10 from the ball body 20. Especially when the tire pressure detector 10 is a commercially available component, a new tire pressure detector 10 is efficiently acquired for replacement, such that the tire pressure detector 10 is efficiently and conveniently assembled in the ball body 20 without the need of a valve stem to be installed on the wheel frame. Also, a waste of component is prevented.

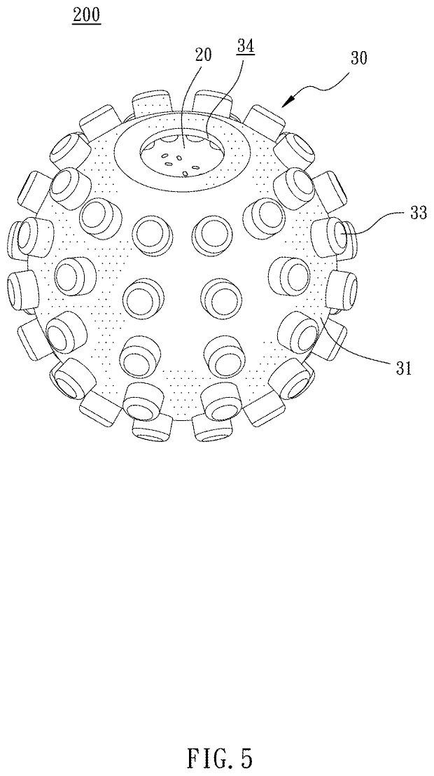

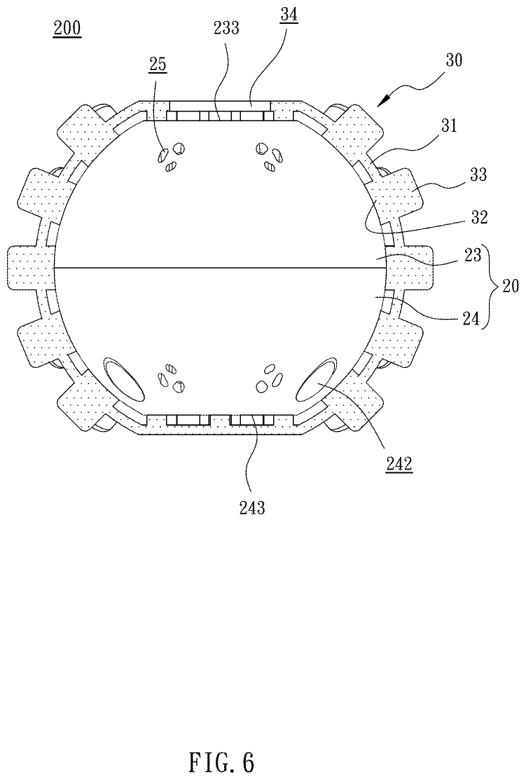

Referring to FIG. 5 to FIG. 6, a spherical tire pressure detection device 200 in accordance with a second embodiment of the present invention is provided, which also has the tire pressure detector 10 and the ball body 20 disclosed in the first embodiment. The main difference between the second embodiment and the first embodiment lies in that a shock absorber 30 is further comprised which is mounted on the outer side of the tire pressure detector 10 and the ball body 20. The shock absorber 30 is hollow and able to be mounted around the ball body 20. When the ball body 20 rolls in the tire, the shock absorber 30 provides a shock absorption effect. Preferably, the shock absorber 30 comprises a main body 31, a plurality of inner protrusions 32, and a plurality of outer protrusions 33, wherein the inner protrusions 32 are formed on the inner surface of the main body 31, and the outer protrusions 33 are formed on the outer surface of the main body 31. In addition, the outer protrusions 33 and the inner protrusions 32 are disposed in opposite on corresponding positions of the outer surface and the inner surface of the main body 31, respectively. Also, the length of the radial direction of the outer protrusions 33 along the ball body 20 is larger than the length of the radial direction of the inner protrusions 32 along the ball body 20. The shock absorber 30 contacts the ball body 20 with the inner protrusions 32, such that an air channel is formed between the neighboring inner protrusions 32, so as to assure that the inner air pressure and the outer pressure of the ball body 20 remain consistent for achieving the accuracy of the detection data. In the embodiment, the shock absorber 30 has an opening 34 whose diameter ranges from ½ to 1/10 of the diameter of the shock absorber 30, so that the opening 34 is able to be opened for mounting the shock absorber 30 around the outer periphery of the ball body 20.

Further, if the gravity center of the ball body 20 deviates from the geometrical center of the ball body 20, the ball body 20 will intensely adhere to the inner wall of the tire during a high-speed rotation of the tire, causing the rotation of the ball body 20. Therefore, to prevent an uneven abrasion of the outer protrusions 33 of the shock absorber 30, in the embodiment, when the casing 11 is positioned by the fixing portion 21, the gravity center of the ball body 20 is kept at the geometrical center of the ball body 20, whereby the ball body 20 only rotates on the bottom portion of the tire during the high-speed rotation of the tire. As a result, the abrasion areas of the outer protrusions 33 of the shock absorber 30 are evenly distributed.

Therefore, in the second embodiment, besides same function provided by the tire pressure detector 10 and the ball body 20, the spherical tire pressure detection device 200 further comprises the shock absorber 30 for providing a shock absorption effect during the ball body 20 rolling in the tire, so as to lower the shock intensity borne by the tire pressure detector 10 along with the rolling of the ball body 20. Thus, the tire pressure detector 10 is prevented from damage due to the shock, and the service life is prolonged.

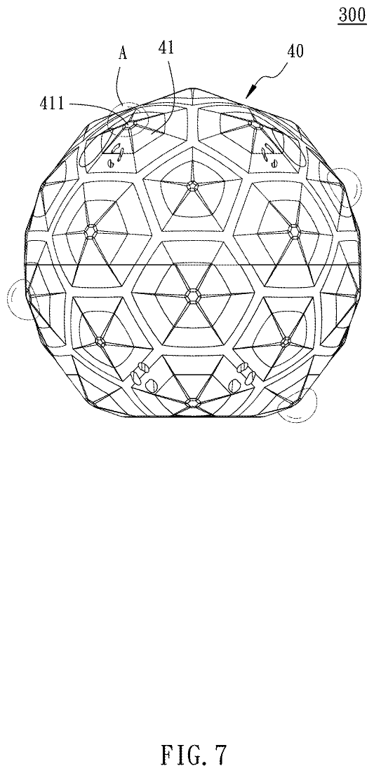

Referring to FIG. 7, a spherical tire pressure detection device 300 in accordance with a third embodiment of the present invention is provided, which also has the tire pressure detector 10 and the ball body 40 disclosed in the first embodiment, wherein the ball body 40 is structurally similar to the ball body 20 of the first embodiment. The main difference lies in that, compared with the relatively smooth surface of the ball body 20, the ball body 40 in the third embodiment has a plurality of lump portions 41, wherein each lump portion 41 is convex from the periphery to the center thereof to form a cone shape and a top end 411 on the end portion of the lump structure. Also, in the embodiment, the periphery of the lump portion 41 is formed in a polygonal shape, such as the hexagonal or pentagonal shaped periphery of the lump portion 41 disclosed in the drawings. The lump portions 41 are averagely distributed on the ball body 40.

Therefore, the spherical tire pressure detection device 300 in the third embodiment has a plurality of lump portions 41 on the outer surface of the ball body 40, with the lump portion 41 being convex from the periphery to the center thereof to form a cone shape, so that when the mist is attached to the ball body 40, the mist is collected on the top end 411 of the lump portion 41 to form a droplet A. With the rolling of the ball body 40, the droplet A is easily threw off, preventing the mist from attaching to the outer surface of the ball body 40 and penetrating into the ball body 40 to damp and damage the tire pressure detector 10. Also, the cone-shaped convex structure of the lump portions 41 provide additional shock absorption effect to the ball body 40.

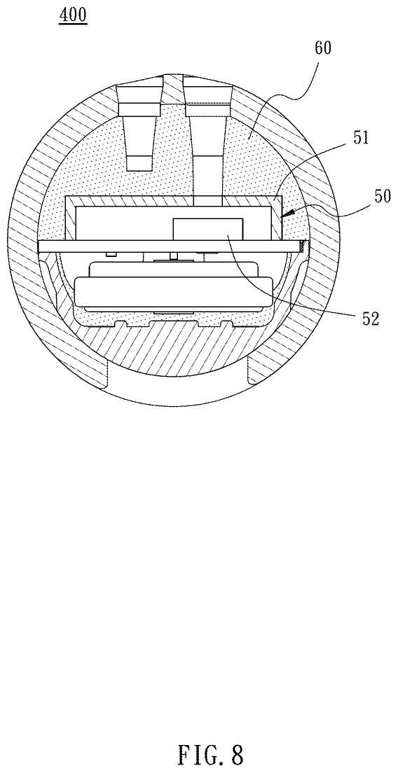

Referring to FIG. 8, a spherical tire pressure detection device 400 in accordance with a fourth embodiment of the present invention comprises a tire pressure detector 50 and a ball body 60, wherein the tire pressure detector 50 comprises a casing 51 and a tire pressure detection member 52. The tire pressure detector 50 is disposed in the ball body 60. When the ball body 60 contains the tire pressure detector 50, the gravity center of the ball body 60 is placed at the geometrical center of the ball body 60. Therefore, the ball body 60 only rolls at the bottom portion of the tire during the high-speed rotation of the tire, so as to prevent the ball body 60 from rotation due to the intense adherence to the inner wall of the tire during the high-speed rotation of the tire.

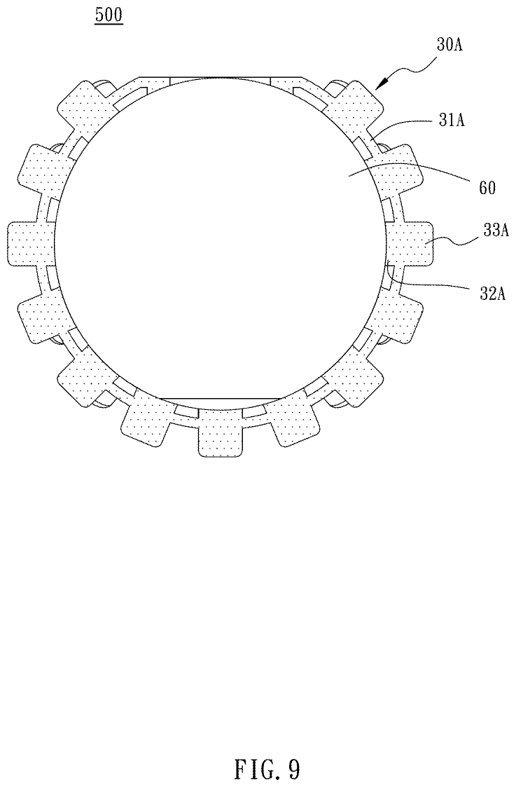

Referring to FIG. 9, a spherical tire pressure detection device 500 in accordance with a fifth embodiment of the present invention is the ball body 60 in accordance with the fourth embodiment having the shock absorber 30A disclosed in accordance with the second embodiment. The shock absorber 30A also has a main body 31A, a plurality of inner protrusions 32A, and a plurality of outer protrusions 33A. The shock absorber 30A has an appearance similar to the appearance of the shock absorber 30, so as to achieve a similar shock absorption effect with the shock absorber 30.

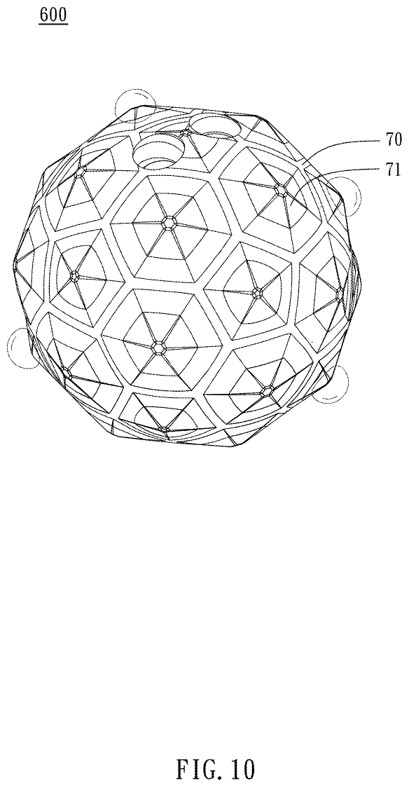

Referring to FIG. 10, a spherical tire pressure detection device 600 in accordance with a sixth embodiment of the present invention has the tire pressure detector 50 (not shown) disclosed in the fourth embodiment and a ball body 70, and the ball body 70 is structurally similar to the ball body 40 in the third embodiment and has a plurality of lump portions 71. Also, the lump portions 71 have identical structure with the lump portions 41 of the ball body 40 in the third embodiment, so as to achieve an identical effect with the ball body 40 for preventing the tire pressure detector 50 from being damped and damaged, and also providing the shock absorption effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A spherical tire pressure detection device, comprising:
a tire pressure detector comprising a casing and a tire pressure detection member disposed in the casing, the tire pressure detection member being applied for detecting a tire pressure in a tire; and
a ball body which is hollow and has a fixing portion, with a housing space formed by the fixing portion, the casing being removably disposed in the housing space and positioned in the ball body by the fixing portion.

2. The spherical tire pressure detection device of claim 1, wherein the ball body comprises a first ball casing and a second ball casing combined together, and at least one of the first ball casing and the second ball casing has a connection bore for communicating an inner space and an outer space of the ball body.

3. The spherical tire pressure detection device of claim 2, wherein the connection bore has an inner section toward the inner space of the ball body, with an outer section surrounding the inner section and having an aperture formed in a tapering horn shape; an end of the outer section having a small aperture is positioned on an inner side of the ball body; the outer section is connected with the inner section in a misalignment manner by channel formed at a lateral side of the outer section and the inner section.

4. The spherical tire pressure detection device of claim 2, wherein the fixing portion is positioned at a center position of one of the first ball casing and the second ball casing; when the casing is in the housing space and positioned by the fixing portion, a gravity center of the ball body is at a geometrical center of the ball body.

5. The spherical tire pressure detection device of claim 2, wherein the first ball casing and the second ball casing are combined through screws, wherein one of the first ball casing and the second ball casing has a plurality of through holes, with the other one of the first ball casing and the second ball casing having a plurality of assembling pillars disposed at positions corresponding to the through holes; each assembling pillar comprises an assembling bore, and each of the screws passes through one of the through hole to be screwed to the corresponding assembling pillar.

6. The spherical tire pressure detection device of claim 1, further comprising a shock absorber, the shock absorber being hollow and mounted around the ball body for providing a shock absorption effect when the ball body is rolling.

7. The spherical tire pressure detection device of claim 6, wherein the shock absorber comprises a main body, with a plurality of inner protrusions disposed on an inner surface of the main body, and a plurality of outer protrusions disposed on an outer surface of the main body, such that the shock absorber contacts the ball body through the plurality of inner protrusions.

8. The spherical tire pressure detection device of claim 7, wherein the outer protrusions and the inner protrusions are disposed in opposite on corresponding positions of the outer surface and the inner surface of the main body, respectively; a length of a radial direction of the outer protrusions along the ball body is larger than a length of a radial direction of the inner protrusions along the ball body.

9. The spherical tire pressure detection device of claim 1, wherein the ball body comprises a plurality of lump portions, and each lump portion is convex from a periphery toward a center of the lump portion to form a cone shape.

10. The spherical tire pressure detection device of claim 9, wherein the periphery of each of the lump portions is formed in a polygonal shape, and the lump portions are averagely distributed on the ball body.

11. A spherical tire pressure detection device, comprising:
a tire pressure detector comprising a casing and a tire pressure detection member disposed in the casing, the tire pressure detection member being applied for detecting a tire pressure in a tire; and
a ball body housing the tire pressure detector, a gravity center of the ball body being positioned at a geometrical center of the ball body.

12. The spherical tire pressure detection device of claim 11, further comprising a shock absorber, the shock absorber being hollow and mounted around the ball body for providing a shock absorption effect when the ball body is rolling.

13. The spherical tire pressure detection device of claim 12, wherein the shock absorber comprises a main body, with a plurality of inner protrusions disposed on an inner surface of the main body, and a plurality of outer protrusions disposed on an outer surface of the main body, such that the shock absorber contacts the ball body through the plurality of inner protrusions.

14. The spherical tire pressure detection device of claim 13, wherein the outer protrusions and the inner protrusions are disposed in opposite on corresponding positions of the outer surface and the inner surface of the main body, respectively; a length of a radial direction of the outer protrusions along the ball body is larger than a length of a radial direction of the inner protrusions along the ball body.

15. The spherical tire pressure detection device of claim 11, wherein the ball body comprises a plurality of lump portions, and each lump portion is convex from a periphery toward a center of the lump portion to form a cone shape.

16. The spherical tire pressure detection device of claim 15, wherein the periphery of each of the lump portions is formed in a polygonal shape, and the lump portions are averagely distributed on the ball body.
